(19) United States
(12) Patent Application Publication
(10) Pub. No.: US 2012/0309871 A1
(43) Pub. Date: Dec. 6, 2012

(54) COMPOSITION OF A BASE FOR AN UMBRELLA

(76) Inventor: FRANK CHEN, KAOHSIUNG CITY (TW)

(21) Appl. No.: 13/150,326

(22) Filed: Jun. 1, 2011

(51) Int. Cl. C04B 14/22

(52) U.S. Cl. 524/2

(57) ABSTRACT

A composition of a base for an umbrella includes 0-45 wt % of a polyresin, 15-75% of cement, 3-5 wt % of water, 3-10 wt % of fiberglass, 7-20 wt % of rocks, 5-15 wt % of sand, and 5-10 wt % of an intensifier. The base meets the requirements of weight and stable support. The base avoids rusting. The base can be coated with a layer of paint, allowing easy processing.

### BACKGROUND OF THE INVENTION

The present invention relates to a composition of a base and, more particularly, to a composition of a base for an umbrella.

Umbrellas are generally used on beaches to shield people from sun and rain water. These umbrellas are generally large and have considerable weights and, thus, need a base for stable support. There are various bases for umbrellas. Bases made of cast iron are liable to rust in the outside even if the bases are coated with a layer of paint. Furthermore, the manufacturing costs of bases made of cast iron are difficult to control due to significant fluctuation of the price of metal. Although the bases can be made of plastic by molding injection, the resultant bases are too light to provide stable support. Furthermore, in addition to consumption of significant energy, it is difficult to control the manufacturing costs of bases made of plastic when the price of petroleum is soaring, because the plastic is a byproduct of petroleum. As for bases made of cement, they are bulky and difficult to process.

Thus, a need exists for a base for an umbrella that can be easily manufactured while allowing easy processing, preventing rusting, and having a sufficient weight to provide reliable support.

### BRIEF SUMMARY OF THE INVENTION

The above need is fulfilled by a base for an umbrella according to the present invention. A composition of the base includes 0-45 wt % of a polyresin, 15-75% of cement, 3-5 wt % of water, 3-10 wt % of fiberglass, 7-20 wt % of rocks, 5-15 wt % of sand, and 5-10 wt % of an intensifier.

The present invention will become clearer in light of the following detailed description of illustrative embodiments of this invention described in connection with the drawings.

### DETAILED DESCRIPTION OF THE INVENTION

A composition of a base for an umbrella according to the present invention includes 0-45 wt % of a polyresin, 15-75% of cement, 3-5 wt % of water, 3-10 wt % of fiberglass, 7-20 wt % of rocks, 5-15 wt % of sand, and 5-10 wt % of an intensifier.

The polyresin can be epoxy resin to increase the plasticity. The polyresin acts as a binding agent and a thermosetting polymer of a mixture. The cement has a considerable weight and, thus, can provide stable support. The function of the water is dissolving and mixing the ingredients. The fiberglass has a light weight, high structural strength, and high design freedom. Furthermore, the fiberglass is resistant to weather and corrosion. Thus, the base can resist corrosion by seawater when used near the seashore. The rocks have larger diameters and can be easily obtained from the environment and used as a reinforcing material. The diameter of the sand is smaller than those of the rocks. The sand can be easily obtained from the environment and used as a reinforcing material. The sand fills the gaps between the rocks. The intensifier improves the dynamic characteristics of the mixture and provides the best enhancing effect. The intensifier can bond the materials to maintain the required shape. Furthermore, the intensifier can transmit and distribute the load in the fiberglass. Thus, the resultant base is durable to pressure and prevent the reinforcing materials from being damaged. Thus, the resultant base is watertight and resistant to chemicals.

The base having the above composition can meet the requirements of weight and stable support as well as resistance to rusting. Furthermore, a layer of paint can be coated on a surface of the base, allowing easy processing.

### Example 1

The composition included 35 wt % of polyresin, 25% of cement, 3 wt % of water, 7 wt % of fiberglass, 15 wt % of rocks, 10 wt % of sand, and 5 wt % of intensifier. A variance of each of the polyresin, the cement, the water, the fiberglass, the rocks, the sand, and the intensifier is 5%. The difference between the weight percentages of the cement and the polyresin was not large, suitable for products requiring a balance between the weight and the plasticity.

### Example 2

The composition included 10 wt % of polyresin, 40% of cement, 5 wt % of water, 5 wt % of fiberglass, 20 wt % of rocks, 15 wt % of sand, and 5 wt % of intensifier. A variance of each of the polyresin, the cement, the water, the fiberglass, the rocks, the sand, and the intensifier is 5%. Since the weight percentages of the cement and the polyresin are respectively 40% and 10%, this composition is suitable for products with a high weight and low plasticity.

### Example 3

The composition included 45 wt % of polyresin, 15% of cement, 5 wt % of water, 10 wt % of fiberglass, 10 wt % of rocks, 5 wt % of sand, and 10 wt % of intensifier. A variance of each of the polyresin, the cement, the water, the fiberglass, the rocks, the sand, and the intensifier is 5%. Since the weight percentages of the cement and the polyresin are respectively 15% and 45%, this composition is suitable for products with a low weight and high plasticity.

### Example 4

The composition included O wt % of polyresin, 75% of cement, 5 wt % of water, 3 wt % of fiberglass, 7 wt % of rocks, 5 wt % of sand, and 5 wt % of intensifier. A variance of each of the polyresin, the cement, the water, the fiberglass, the rocks, the sand, and the intensifier is 5%. Since the weight percentages of the cement and the polyresin are respectively 75% and 0%, this composition is suitable for products with a considerable weight and low plasticity.

The base can be manufactured by automatic mechanical equipment or by hand based on the composition. The composition is poured into a mold. The mold can have any desired shape and pattern. After initial formation, the base is removed from the mold and then baked or exposed to the sun for drying and taking shape.

Although specific embodiments have been illustrated and described, numerous modifications and variations are still possible without departing from the essence of the invention. The scope of the invention is limited by the accompanying claims.

1. A composition of a base for an umbrella, the composition including substantially 35 wt % of polyresin, 25 wt % of cement, 3 wt % of water, 7 wt % of fiberglass, 15 wt % of rocks, 10 wt % of sand, and 5 wt % of intensifier, with a variance of the weight percentage of each of the polyresin, the cement, the water, the fiberglass, the rocks, the sand, and the intensifier being 5%.

2. (canceled)

3. A composition of a base for an umbrella, the composition including substantially 10 wt % of polyresin, 40 wt % of cement, 5 wt % of water, 5 wt % of fiberglass, 20 wt % of rocks, 15 wt % of sand, and 5 wt % of intensifier, with a variance of the weight percentage of each of the polyresin, the cement, the water, the fiberglass, the rocks, the sand, and the intensifier being 5%.

4. A composition of a base for an umbrella, the composition including substantially 45 wt % of polyresin, 15 wt % of cement, 5 wt % of water, 10 wt % of fiberglass, 10 wt % of rocks, 5 wt % of sand, and 10 wt % of intensifier, with a variance of the weight percentage of each of the polyresin, the cement, the water, the fiberglass, the rocks, the sand, and the intensifier being 5%.

5. (canceled)
